(19) United States
(12) Patent Application Publication
(10) Pub. No.: US 2016/0326655 A1
(43) Pub. Date: Nov. 10, 2016

(54) SUBSTRATE TREATED WITH COLOR DEVELOPMENT, AND SUBSTRATE COLOR DEVELOPMENT TREATMENT METHOD FOR SAME

(71) Applicant: POSCO, Pohang-si (KR)

(72) Inventors: Hyunju JEONG, Hwaseong-si, Gyeonggi-do (KR); Yon-Kyun SONG, Incheon (KR); Min Hong Hong SEO, Incheon (KR); Kanghwan AHN, Incheon (KR); Yeong-Woo JEON, Incheon (KR)

(21) Appl. No.: 15/108,512

(22) PCT Filed: Dec. 26, 2014
(86) PCT No.: PCT/KR2014/012931

§ 371 Date: Jun. 27, 2016

(30) Foreign Application Priority Data
Dec. 26, 2013 (KR) 10-2013-0164044
Dec. 26, 2013 (KR) 10-2013-0164045
Dec. 26, 2013 (KR) 10-2013-0164046
Dec. 26, 2013 (KR) 10-2013-0164047
Dec. 26, 2014 (KR) 10-2014-0190347
Dec. 26, 2014 (KR) 10-2014-0190373

(51) Int. Cl. C23C 22/64; C09D 5/08; C23C 22/73

(52) U.S. Cl. CPC C23C 22/64; C23C 22/73; C09D 5/08

(57) ABSTRACT

A substrate containing magnesium treated with color development, according to the present invention, comprises a coating having a structure in which crystals having a plate-shaped structure are horizontally even and densely stacked on a matrix containing magnesium, thereby maintaining a texture and sheen unique to the metal while enabling even development of a plurality of colors on the surface by controlling the average thickness of the coating, according to the amount of stacking of the crystals, and thus can be useful in areas using metal materials, such as external materials for construction, vehicle interiors, and especially in electrical and electronic parts material fields such as in mobile phone case parts.

### TECHNICAL FIELD

The present invention relates to a color-treated substrate including magnesium and a substrate color treatment method therefor, and specifically, to a color-treated substrate including magnesium which maintains a texture and gloss of metals and uniformly develops a variety of colors, and a substrate color treatment method therefor.

### BACKGROUND ART

Magnesium is a metal which belongs to lightweight metals among practical metals, has excellent wear resistance, and is very resistant to sunlight and eco-friendly, but has a difficulty in realizing a metal texture and various colors. Further, since it is a metal having the lowest electrochemical performance and is highly active, when a color treatment is not performed thereon, it may be quickly corroded in air or in a solution, and thus has a difficulty in industrial application.

Recently, the magnesium industry has been receiving attention due to the weight reduction trend in the overall industry. As exterior materials with a metal texture has become trendy in the field of electrical and electronic component materials such as mobile product frames, research to resolve the above-described problem of magnesium is being actively carried out.

As a result, Korean Patent Laid-open Publication No. 2011-0016750 disclosed a PVD-sol gel method of performing sol-gel coating after dry coating a surface of a substrate formed of a magnesium alloy with a metal-containing material in order to realize a metal texture and ensure corrosion resistance, and Korean Patent Laid-open Publication No. 2011-0134769 disclosed an anodic oxidation method of imparting gloss to a surface of a substrate including magnesium using chemical polishing and coloring a surface by anodic oxidation of the substrate in an alkaline electrolyte including a pigment dissolved therein.

However, the PVD-sol gel method has a problem in that a texture realized on the surface of the substrate is not the intrinsic texture of magnesium although a metal texture may be realized on the surface of the substrate, and the realization of a variety of colors is difficult. Furthermore, when a color treatment is performed using the anodic oxidation method, there is a problem in that an opaque oxide film is formed on the surface of the substrate, and the realization of the intrinsic texture of metals is not easy.

Accordingly, there is an urgent need for a technique to improve corrosion resistance by chemically, electrochemically or physically treating the surface of the substrate and to realize a desired color on the surface for commercialization of a substrate including magnesium.

### DISCLOSURE

### Technical Problem

In order to solve the problem, an objective of the present invention is to provide a color-treated substrate including magnesium, which maintains the texture and gloss of metals and uniformly develops a variety of colors.

Another objective of the present invention is to provide a method of color-treating the substrate.

### Technical Solution

In order to achieve the objectives, an embodiment of the present invention provides a color-treated substrate, including:

a matrix containing magnesium; and

a film formed on the matrix,

wherein the film includes a crystal having a plate-shaped structure and an average size in the range of 50 to 100 nm, and containing a compound represented by the following Chemical Formula 1:

M(OH)ₘ [Chemical Formula 1]

where M includes one or more selected from the group consisting of Na, K, Mg, Ca and Ba, and m is 1 or 2,

wherein the crystal satisfies a condition of the following Expression 1:

α≦30° [Expression 1]

where α represents an average tilt angle formed by a surface of the matrix or a plane which is parallel with the surface of the matrix, and any axis existing on a major axis plane of the crystal.

Further, another embodiment of the present invention provides a method of color-treating a substrate, including a step of forming a film on a matrix containing magnesium,

wherein the film has a structure in which crystals having a plate-shaped structure and an average size in the range of 50 to 100 nm, and containing a compound represented by the following Chemical Formula 1 are stacked such that an average tilt angle formed by a surface of the matrix or a plane which is parallel with the surface of the matrix, and any axis existing on a major axis plane of the crystal is 30° or less:

M(OH)ₘ [Chemical Formula 1]

where M includes one or more selected from the group consisting of Na, K, Mg, Ca and Ba, and m is 1 or 2.

### Advantageous Effects

The color-treated substrate according to the present invention can maintain an intrinsic texture and glossiness of metals and uniformly develop a variety of colors by controlling an average thickness of a film according to the degree of stacking of crystals, and thus can be usefully used in the fields of building exterior materials, automobile interiors, and particularly electrical and electronic component materials, such as mobile product frames, in which a metal material is used.

### DESCRIPTION OF DRAWINGS

FIG. 1 is a graph showing a result of an X-ray diffraction measurement of a film included in a color-treated substrate according to the present invention in an embodiment.

FIG. 2 shows images of a surface form of a film according to a type of a hydroxide solution, which are taken by a scanning electron microscope (SEM) in an embodiment.

### MODES OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Further, in the drawings of the present invention, the size and relative sizes of layers, regions and/or other elements may be exaggerated or reduced for clarity.

The embodiments of the present invention will be described with reference to the drawings. Throughout the specification, like reference numerals designate like elements and a repetitive description thereof will be omitted.

“Color coordinates”, as used herein, refer to coordinates in a CIE color space, including color values defined by the Commission International de l'Eclairage (CIE), and any position in the CIE color space may be expressed as three coordinate values of L*, a* and b*.

Here, an L* value represents brightness. L*=0 represents a black color, and L*=100 represents a white color. Moreover, an a* value represents whether a color at a corresponding color coordinate leans toward a pure magenta color or a pure green color, and a b* value represents whether a color at a corresponding color coordinate leans toward a pure yellow color or a pure blue color.

Specifically, the a* value ranges from −a to +a, the maximum a* value (a* max) represents a pure magenta color, and the minimum a* value (a* min) represents a pure green color. For example, when an a* value is negative, a color leans toward a pure green color, and when an a* value is positive, a color leans toward pure magenta color. This indicates that, when a*=80 is compared with a*=50, a*=80 shows a color which is closer to a pure magenta color than a*=50. Furthermore, the b* value ranges from −b to +b. The maximum b* value (b* max) represents a pure yellow color, and the minimum b* value (b* min) represents a pure blue color. For example, when a b* value is negative, a color leans toward a pure yellow color, and when a b* value is positive, a color leans toward a pure blue color. This indicates that, when b*=50 is compared with b*=20, b*=80 shows a color which is closer to a pure yellow color than b*=50.

Further, a “color deviation” or a “color coordinate deviation”, as used herein, refers to a distance between two colors in the CIE color space. That is, a longer distance denotes a larger difference in color, and a shorter distance denotes a smaller difference in color, and this may be expressed by ΔE* represented by the following Expression 5:

ΔE*=\sqrt{(ΔL*)²+(Δa*)²+(Δb*)²} [Expression 5]

Further, a unit “T”, as used herein, represents a thickness of a substrate including magnesium, and is the same as a unit “mm”

Lastly, a “tilt angle α”, as used herein, refers to the largest angle among angles formed by a surface of the matrix or a plane which is parallel with the surface of the matrix, and any axis existing on a major axis plane of the crystal.

The present invention provides a color-treated substrate including magnesium and a substrate color treatment method therefor.

A PVD-sol gel method, an anodic oxidation method or the like, which is a method of coating a surface of a material with a metal-containing material, a pigment or the like, has been conventionally known as a method for realizing a color on the material including magnesium. However, these methods may cause a reduction in durability of the substrate. Further, it is difficult to realize a uniform color on the surface of the material, and there is a problem of unmet reliability because a coated film layer is easily detached. Particularly, the intrinsic texture of metals is not realized in these methods, and thus they are difficult to be applied in the fields of building exterior materials, automobile interiors, and particularly electrical and electronic component materials, such as mobile product frames, in which a metal material is used.

In order to address these issues, the present invention suggests a color-treated substrate including magnesium and a substrate color treatment method therefor according to the present invention.

The color-treated substrate according to the present invention includes a film which has a structure in which crystals having a plate-shaped structure are horizontally uniform and densely stacked on a matrix containing magnesium, and thus may maintain the intrinsic texture and glossiness of metals and uniformly develop a variety of colors on a surface by controlling an average thickness of a film according to the degree of stacking of the crystals.

Hereinafter, the present invention will be described in further detail.

An embodiment of the present invention provides color-treated substrate, including:

a matrix containing magnesium; and

a film formed on the matrix,

wherein the film includes crystals having a plate-shaped structure and an average size in the range of 50 to 100 nm, and containing a compound represented by the following Chemical Formula 1:

M(OH)ₘ [Chemical Formula 1]

where M includes one or more selected from the group consisting of Na, K, Mg, Ca and Ba, and m is 1 or 2,

wherein the crystals satisfy a condition of the following Expression 1:

α≦30° [Expression 1]

where α represents an average tilt angle formed by a surface of the matrix or a plane which is parallel with the surface of the matrix, and any axis existing on a major axis plane of a crystal.

Specifically, the color-treated substrate may satisfy the condition of Expression 1 as follows: 30° or less, 29° or less, 28° or less, 27° or less or 26° or less.

The color-treated substrate according to the present invention includes a matrix containing magnesium and a film, and develops a color on a surface by scattering and refracting light incident to the surface through the film disposed on the matrix.

Here, the film may have a structure in which crystals having a plate-shaped structure and containing a compound represented by Chemical Formula 1 are stacked, and the compound represented by Chemical Formula 1 may be one or more of sodium hydroxide (NaOH), potassium hydroxide (KOH), magnesium hydroxide (Mg(OH)₂), calcium hydroxide (Ca(OH)₂) and barium hydroxide (Ba(OH)₂), and more specifically, may be magnesium hydroxide (Mg(OH)₂).

As an example, the color-treated substrate may have 2θ diffraction peak values of 18.5±1.0°, 38.0±1.0°, 50.5±1.0°, 58.5±1.0°, 62.0±1.0° and 68.5±1.0° when an X-ray diffraction measurement is performed on the surface provided with the film, and the diffraction peak values may satisfy a condition of the following Expression 2:

P₁/P₂≧0.9 [Expression 2]

where P₁ is an intensity of a diffraction peak of 18.5±1.0° at 2θ, and P₂ is an intensity of a diffraction peak of 38.0±1.0° at 2θ.

Here, the substrate has a ratio between P₁ and P₂ of 0.9 or more, 1.0 or more, 1.1 or more, 1.2 or more or 1.5 or more to satisfy the condition of Expression 2.

Specifically, as a result of the X-ray diffraction measurement of the surface of the color-treated substrate, 2θ diffraction peak values of 18.5±1.0°, 38.0±1.0°, 50.5±1.0°, 58.5±1.0°, 62.0±1.0° and 68.5±1.0°, which are diffraction peak values of magnesium, were determined. Further, it was determined that, among the diffraction peak values, intensities of peaks at 18.5±1.0° at 2θ were the highest, and had a ratio of about 1.66 to 4.8 with peaks at 38.0±1.0° at 2θ. These results of X-ray diffraction are the same as that of a brucite crystalline form, that is, that of magnesium hydroxide having a hexagonal shape, and thus indicates that the film formed on the matrix has a structure in which magnesium hydroxide (Mg(OH)₂) having hexagonal crystals and a plate-shaped structure are stacked. From these results, it can be determined that the color-treated substrate according to the present invention satisfies the condition of Expression 2 (refer to Experimental Example 1).

Further, the size of crystals of the film is not particularly limited, but the average size of the crystals may be in the range of 50 to 100 nm

Generally, fine and uniform particles in a tissue reduce defect size and residual stress which may become the cause of a decrease in strength occurring in the tissue, and thus may increase the strength of the tissue. That is, when the crystals have an average size in the range of 50 to 100 nm, crystals may be horizontally uniform and densely stacked on a matrix without forming empty spaces between the crystals, and thus not only may prevent diffusion of light incident to a substrate surface to maintain the intrinsic texture and gloss of metals, but also may improve durability of the substrate.

Specifically, the surface of the color-treated substrate was observed with the naked eye and using a scanning electron microscope (SEM). As a result, it can be confirmed with the naked eye that the color-treated substrate maintains the intrinsic gloss of metals and has a uniformly developed color. Furthermore, from the results of observation by scanning electron microscopy, it can be determined that the surface of the substrate has a structure in which crystals having a size in the range of about 50 to 100 nm are horizontally and densely stacked on a surface of a matrix such that an average tilt angle α formed by the surface of the matrix and any axis existing on a major axis plane of the crystal is 30° or less. From these results, it can be seen that the color-treated substrate according to the present invention includes a film in which crystals having a plate-shaped structure are uniformly and densely stacked on a matrix containing magnesium, and satisfies the condition of Expression 1 (refer to Experimental Example 3).

Further, the color-treated substrate according to the present invention may realize a variety of colors by controlling an average thickness of a film formed on a matrix. The film may adjust a developed color by controlling properties of incident light transmitted to a matrix surface and light reflected from the matrix surface according to the average thickness of the film. Here, the average thickness of the film is not particularly limited, but may be in the range of 1 to 900 nm, specifically, in the range of 1 to 800 nm; 1 to 700 nm; or 1 to 600 nm Specifically, as a result of evaluating a color developed according to an average thickness of a substrate including magnesium according to the present invention, it was determined that a yellow color was developed when a film having an average thickness of about 200±50 nm was formed on a matrix. Further, it was determined that a green color was developed when a film having an average thickness of about 600±50 nm was formed on a matrix. From these results, it can be seen that scattering and refraction of light incident to a matrix surface are changed in accordance with a thickness of a film formed on a matrix to generate a color deviation of a developed color.

Further, the color-treated substrate according to the present invention may further include a wavelength conversion layer and a top coat formed on the film.

The top coat may be further included in order to improve scratch resistance and durability of the surface of the substrate including magnesium. Here, a clear coating agent for forming the top coat is not particularly limited as long as it is a clear coating agent which is applicable to coatings of metals, metal oxides or metal hydroxides. More specifically, a matte clear coating agent or a glossy/matte clear coating agent which is applicable to metal coatings or the like may be exemplified.

Further, the top coat may have an excellent adhesiveness with the wavelength conversion layer. Specifically, when the color-treated substrate including the top coat was sprayed with 5 wt % salt water at 35° C. and the adhesiveness thereof was evaluated after 72 hours, a peel rate of the top coat may be 5% or less.

Further, an embodiment of the present invention provides a method of color-treating a substrate, including a step of forming a film on a matrix containing magnesium, wherein the film has a structure in which a crystal having a plate-shaped structure and an average size in the range of 50 to 100 nm, and containing a compound represented by the following Chemical Formula 1 is stacked such that an average tilt angle formed by a surface of the matrix or a plane which is parallel with the surface of the matrix, and any axis existing on a major axis plane of the crystal is 30° or less:

M(OH)ₘ [Chemical Formula 1]

where M includes one or more selected from the group consisting of Na, K, Mg, Ca and Ba, and m is 1 or 2,

The method of color-treating the substrate according to the present invention includes a step of forming a film on a matrix containing magnesium, and the method for performing the step of forming the film is not particularly limited as long as the method is a generally used to form a film on a metal substrate in the related field. Specifically, the film may be formed by immersing the substrate including magnesium in a hydroxide solution.

Here, the hydroxide solution is not particularly limited as long as the solution includes a hydroxyl group (—OH group). Specifically, the solution having one or more selected from the group consisting of NaOH, KOH, Mg(OH)₂, Ca(OH)₂ and Ba(OH)₂ dissolved therein may be used. The present invention has an advantage in that the film is uniformly formed on the matrix surface in a short time and the intrinsic gloss and texture of metals are maintained by using the hydroxide solution as an immersion solution.

Further, the preparation method according to the present invention may control the thickness of the film formed on the surface of the matrix according to immersion conditions. Here, since the amount of heat conduction of the matrix varies depending on the thickness of the matrix, when the thicknesses of the matrices are different, the thickness of the films formed on matrices may be different even though the matrices were immersed under the same conditions. Accordingly, it is preferable to control the thickness of the film by adjusting immersion conditions according to the thickness of the matrix containing magnesium.

As an example, when the thickness of the matrix containing magnesium is in the range of 0.4 to 0.7 T, the concentration of the hydroxide solution may range from 1 to 20 wt %, and more specifically, from 1 to 15 wt %. Moreover, the temperature of the hydroxide solution may range from 90 to 200° C., more specifically, from 100 to 150° C., and even more specifically, from 95 to 110° C. Further, the immersion time may be in the range of 1 to 180 minutes, and specifically, in the range of 5 to 90 minutes. In the step of forming the film, various colors may be economically realized on the surface of the substrate and the growth rate of crystals is easily controlled, and thus an excess increase in the average thickness of the film due to the overgrowth of crystals is prevented, and the intrinsic texture and gloss of metals may be maintained.

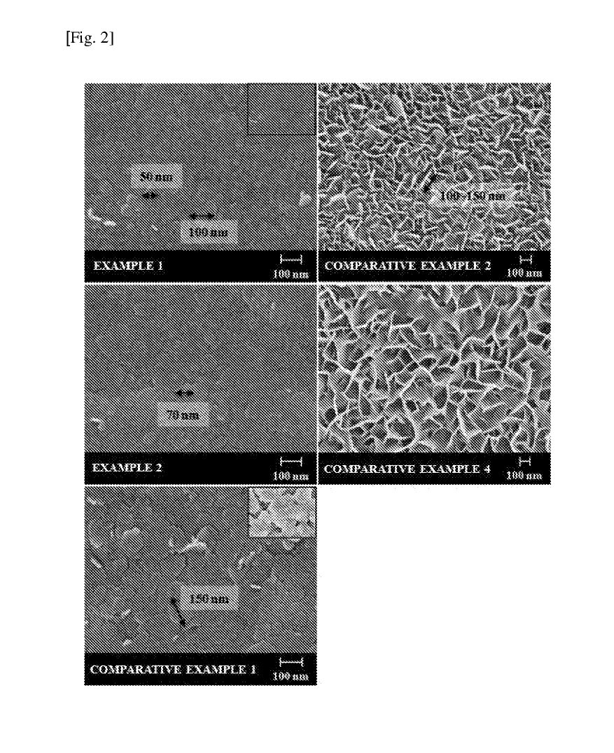

Referring to FIG. 2, in the case of the substrate immersed in a 10 wt % NaOH solution at 100° C. for 180 minutes or less, it can be determined that crystals having a diameter in the range of 50 to 100 nm and a plate-shaped structure are horizontally and densely stacked to form a film. In contrast, in the case of the substrate immersed for 240 minutes, it can be determined that crystals grow to have a diameter or more than 100 nm, and the surface is not uniform (refer to Experimental Example 3).

Moreover, the step of forming the film may include: a first immersion step of immersing the matrix containing magnesium in a hydroxide solution with a concentration of N₁; and an n^{th} immersion step of immersing the matrix in a hydroxide solution with a concentration of Nₙ, and the first immersion step and the n^{th} immersion step may be carried out using a method in which the concentration of the hydroxide solution satisfies the following Expressions 4 and 5 independently of each other, and n is an integer of 2 or more and 6 or less:

8≦N₁≦25 [Expression 4]

|Nₙ₋₁−Nₙ|>³ [Expression 5]

where N₁ and Nₙ represent a concentration of a hydroxide solution in each step, and have units of wt %.

As described above, the step of immersing in the hydroxide solution is a step of realizing a color by forming a film on the surface of the substrate including magnesium, and the developed color may be controlled by adjusting the thickness of the formed film. Here, since the thickness of the film may be controlled according to the concentration of the hydroxide solution, when the concentration of the hydroxide solution for immersing the matrix is divided into N₁ to Nₙ, and specifically, N₁ to N₆; N₁ to N₅; N₁ to N₄; N1 to N₃; or N₁ to N₂; and the matrix is sequentially immersed therein, minute differences in the color realized on the surface may be controlled.

Further, the method of color-treating the substrate according to the present invention substrate may further include one or more steps of: pretreating a surface before the step of forming the film; and rinsing after the step of forming the film.

Here, the step of pretreating the surface is a step of eliminating contaminants remaining on the surface by treating the surface using an alkaline cleaning solution or grinding the surface before forming the film on the matrix. Here, the alkaline cleaning solution is not particularly limited as long as the solution is generally used to clean a surface of metals, metal oxides or metal hydroxides in the related field. Further, the grinding may be performed by buffing, polishing, blasting, electrolytic polishing or the like, but is not limited thereto.

In the present step, not only contaminants or scale which is present on the surface of the matrix containing magnesium may be removed, but also the speed of forming the film may be controlled by surface energy of the surface and/or surface conditions, specifically, microstructural changes of the surface. That is, the thickness of the film formed on the polished matrix may be different from that of the film formed on the unpolished matrix even though the film is formed on the polished matrix under the same conditions as the film of the unpolished matrix, and each color developed on the surface may be different accordingly.

Moreover, the step of rinsing is a step of eliminating any hydroxide solution remaining on the surface by rinsing the surface of the matrix after forming the film on the matrix, specifically after the step of immersing the matrix in the hydroxide solution. In this step, additional formation of the film due to any remaining hydroxide solution may be prevented by removing the hydroxide solution remaining on the surface of the matrix.

### MODE FOR THE INVENTION

Hereinafter, the present invention will be described in further detail with reference to examples and experimental examples.

However, the following examples and experimental examples are for illustrative purposes only and not intended to limit the scope of the present invention.

### Examples 1 to 3

A magnesium-containing sample with a size of 1 cm×1 cm×0.4 T was degreased by immersing in an alkaline cleaning solution, and the degreased sample was immersed in a 10 wt % NaOH solution at 100° C. for the time shown in Table 1. Thereafter, the sample was rinsed using distilled water and dried in a drying oven to prepare a color-treated sample.

TABLE 1

| | Immersion time |
|---|---|
| Example 1 | 30 minutes |
| Example 2 | 80 minutes |
| Example 3 | 170 minutes |

### Comparative Examples 1 to 4

A magnesium-containing sample with a size of 1 cm×1 cm×0.4 T was degreased by immersing in an alkaline cleaning solution, and the degreased sample was immersed in an immersion solution at 100° C. as shown in the following Table 2. Thereafter, the sample was rinsed using distilled water and dried in a drying oven to prepare a color-treated sample.

TABLE 2

| | Immersion solution | Immersion time |
|---|---|---|
| Comparative Example 1 | 10 wt % NaOH solution | 240 minutes |
| Comparative Example 2 | Distilled water | 40 minutes |
| Comparative Example 3 | Distilled water | 60 minutes |
| Comparative Example 4 | Distilled water | 120 minutes |

### Experimental Example 1

### Analysis of Component and Structure of Film

In order to determine components forming a film and a structure of the film, the following experiment was performed.

X-ray diffraction (XRD) of samples obtained in Examples 1 to 3, and Comparative Example 2 was measured. Here, Rigaku ultra-X (CuKa radiation, 40 kV, 120 mA) was used as a measuring device. Further, as measurement conditions, an X-ray diffraction pattern in the range of 10 to 80° at 2θ was obtained by radiation at a wavelength of 1.5406 Å with a scanning speed of 0.02°/sec.

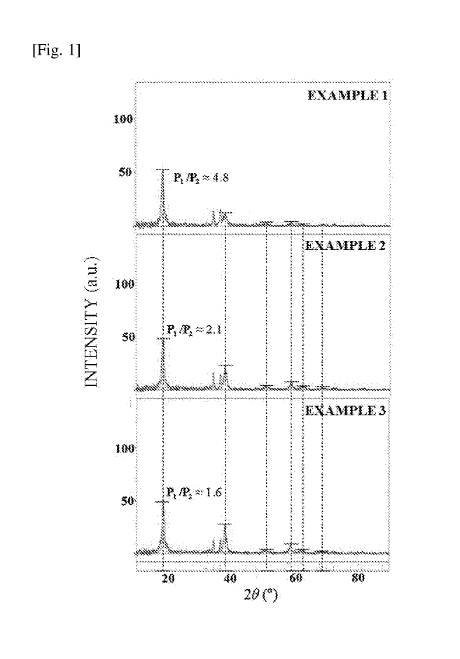

Furthermore, an average thickness of the film stacked on the magnesium sample was measured by performing transmission electron microscope (TEM) imaging on samples obtained in Examples 1 to 3, and the measurement results are shown in FIG. 1 and the following Table 3.

TABLE 3

| | | Immersion | Film average |
|---|---|---|---|
| | Immersion solution | time (min) | thickness (nm) |
| Example 1 | 10 wt % NaOH solution | 30 | 200 ± 50 |
| Example 2 | 10 wt % NaOH solution | 80 | 600 ± 50 |
| Example 3 | 10 wt % NaOH solution | 170 | 800 ± 50 |

Referring to FIG. 1, the samples obtained in Examples 1 to 3 were determined to have 2θ diffraction peaks values of 18.5±1.0°, 38.0±1.0°, 50.5±1.0°, 58.5±1.0°, 62.0±1.0° and 68.5±1.0° of magnesium as a matrix. Further, it was determined that, in the diffraction peak values, intensities of peaks at 18.5±1.0° at 2θ were the highest, and had a ratio of about 1.66 to 4.8 with peaks at 38.0±1.0° at 2θ. Here, the diffraction peak values and patterns are the same as those of a brucite crystalline form, that is, magnesium hydroxide having a hexagonal shape, and thus indicates that the film formed on the matrix has a structure in which magnesium hydroxide (Mg(OH)₂) having hexagonal crystals and a plate-shaped structure are stacked. In contrast, it was determined that 2θ diffraction peaks values of the sample obtained in Comparative Example 2 were similar to those of the samples of the examples, but intensities of peaks at 18.5±1.0° at 2θ were low, and had a ratio of about 0.4 with peaks at 38.0±1.0° at 2θ. This indicates that the film formed on the sample of Comparative Example 2 has a structure in which crystals of magnesium hydroxide are stacked, but the structure in which these crystals are stacked on the matrix is different from that of the examples.

Further, referring to Table 3, the thickness of the film was determined to increase as immersion time increases. Specifically, in the case of the samples of Examples 1 to 3 of which the immersion time was respectively 30 minutes, 80 minutes and 170 minutes, it was determined that the average thickness of the film was 200±50 nm, 600±50 nm and 800±50 nm, respectively.

From these results, it can be determined that the color-treated substrate according to the present invention includes a film in which crystals having a plate-shaped structure and containing a compound represented by the following Chemical Formula 1 are stacked, and the average thickness of the film is in the range of 1 to 900 nm, which increases as the time of immersing the substrate increases.

### Experimental Example 2

### Evaluation of Coloring of Substrate According to Immersion Time

In order to evaluate a color developed on the surface and color uniformity depending on immersion time, the following experiment was performed.

A magnesium-containing sample with a size of 1 cm×1 cm×0.4 T was degreased by immersing in an alkaline cleaning solution, and the degreased sample was immersed in a 10 wt % NaOH solution at 100° C. for 170 minutes. Here, the color of the surface of the sample was observed with the naked eye at intervals of 5 to 10 minutes immediately after the sample was immersed in the NaOH solution to determine a developed color. Further, any three points A to C which are present on each surface of the samples which were color-treated in Examples 2 and 3 were selected, and measurement of color coordinates in a CIE color space of the selected points were repeated 4 times to calculate average color coordinates (L*, a*, b*) and color coordinate deviations. The result is shown in the following Table 4.

TABLE 4

| | L* | a* | b* | ΔL* | Δa* | Δb* | ΔE* |
|---|---|---|---|---|---|---|---|
| Example 2 | 66.44 | 3.39 | 24.20 | 0.26 | 0.18 | 0.19 | 0.36892 |
| Example 3 | 54.56 | −5.75 | 10.45 | 0.21 | 0.19 | 0.39 | 0.48196 |

It can be seen that the color-treated substrate according to the present invention may develop a variety of colors on the surface according to immersion time.

Specifically, when the sample including magnesium was immersed in the hydroxide solution, a silver color which is an intrinsic color of magnesium is maintained for 30 minutes, and then yellow, magenta, purple, navy and green colors were sequentially and uniformly developed. This indicates that a color developed on the matrix surface may be adjusted by controlling the immersion time of the matrix.

Further, referring to Table 4, it can be seen that the color uniformity of the color developed on the color-treated substrate is excellent. Specifically, the color coordinate deviations of the sample of Example 2 were determined as 0.25<ΔL*<0.30, 0.15≦Δa*<0.20, 0.15<Δb*<0.20 and ΔE*<0.400. Further, the color coordinate deviations of the sample of Example 3 were determined as 0.20<ΔL*<0.25, 0.15≦Δa*<0.20, 0.35≦Δb*<0.40 and 0.45≦ΔE*<0.500, that is, deviations were small.

From these results, it can be determined that a variety of colors may be uniformly developed on the surface of the substrate by controlling a time of immersing the matrix containing magnesium in a hydroxide solution with a concentration of 1 to 20 wt % and a temperature of 50 to 200° C., such as a NaOH, KOH, Mg(OH)₂, Ca(OH)₂ and Ba(OH)₂ solution.

### Experimental Example 3

### Analysis of Film Structure According to Immersion Solution

In order to evaluate influences of a type of an immersion solution and immersion time to formation of the film of the color-treated substrate according to the present invention, the following experiment was performed.

The color and glossiness of the surface of the color-treated magnesium samples prepared in Examples 1 and 2, Comparative Examples 1, 2 and 4 were evaluated with the naked eye. Then, the film formed on the surface of the film was observed using a scanning electron microscope (SEM) at a magnification of 50,000×, and the result is shown in FIG. 2.

As a result of observing the color-treated samples, it was determined that the samples of Examples 1 and 3 maintained the intrinsic color of metals and coloring was uniform. On the other hand, it was determined that the samples of comparative examples had low coloring power and significantly decreased gloss, although coloring was uniform.

Further, referring to FIG. 2, it can be determined that the samples of Examples 1 and 2 includes a film in which crystals having an average size in the range of 50 to 100 nm and having a plate-shaped structure are stacked. Further, it can be determined that almost no gap is present between the crystals forming the film. This indicates that an average tilt angle formed by the surface of the matrix, and any axis existing on the major axis plane of the crystal is 30° or less, that is, the average tilt angle is low.

On the other hand, in the case of the sample according to Comparative Example 1, it can be determined that the average size of the crystals forming the film is more than 100 nm and the surface is not uniform. Further, it can be determined that the samples according to Comparative Examples 2 and 4 include a film having a structure in which an average tilt angle formed by the surface of the matrix, and any axis existing on the major axis plane of the crystal is in the range of about 75 to 105°, and crystals form an irregular network.

From these results, it can be determined that crystals having a plate-shaped structure are horizontally and densely stacked on a matrix by immersing the matrix containing magnesium in a hydroxide solution with a concentration of 1 to 20 wt % and a temperature of 50 to 200° C., such as a NaOH, KOH, Mg(OH)₂, Ca(OH)₂ and Ba(OH)₂ solution. Further, it can be determined that a substrate on which a color is uniformly developed may be obtained by this stacked structure, without a decrease in the intrinsic glow of metals.

### INDUSTRIAL APPLICABILITY

The color-treated substrate according to the present invention can maintain an intrinsic texture of metals and glossiness and uniformly develop a variety of colors by controlling an average thickness of a film according to the degree of stacking of crystals, and thus can be usefully used in the fields of building exterior materials, automobile interiors, and particularly electrical and electronic component materials, such as mobile product frames, in which a metal material is used.

1. A color-treated substrate, comprising:
a matrix containing magnesium; and
a film formed on the matrix,
wherein the film includes crystals having a plate-shaped structure and an average size in a range of 50 to 100 nm, and containing a compound represented by the following Chemical Formula 1:
M(OH)ₘ [Chemical Formula 1]
where M includes one or more selected from the group consisting of Na, K, Mg, Ca and Ba, and m is 1 or 2,
wherein the crystals satisfy a condition of the following Expression 1:
α≦30° [Expression 1]
where represents an average tilt angle formed by a surface of the matrix or a plane which is parallel with the surface of the matrix, and any axis existing on a major axis plane of a crystal.

2. The color-treated substrate according to claim 1, wherein a condition of the following Expression 2 is satisfied when the color-treated substrate is measured by X-ray diffraction:
P₁/P₂≧0.9 [Expression 2]
where P₁ is an intensity of a diffraction peak of 18.5±1.0° at 2θ, and P₂ is an intensity of a diffraction peak of 38.0±1.0° at 2θ.

3. The color-treated substrate according to claim 1, wherein 2θ diffraction peak values are 18.5±1.0°, 38.0±1.0°, 50.5±1.0°, 58.5±1.0°, 62.0±1.0° and 68.5±1.0° when the color-treated substrate is measured by X-ray diffraction.

4. The color-treated substrate according to claim 1, wherein, at any three points included in an arbitrary region with a width of 1 cm and a length of 1 cm which is present on the film, an average color coordinate deviation (ΔL*, Δa*, Δb*) of each point satisfies one or more conditions of ΔL*<0.4, Δa*<0.3 and Δb*<0.5.

5. The color-treated substrate according to claim 1, wherein an average thickness of the film is in a range of 1 to 900 nm.

6. The color-treated substrate according to claim 1, further comprising a top coat formed on the film.

7. A method of color-treating a substrate, comprising a step of forming a film on a matrix containing magnesium,
wherein the film has a structure in which crystals having a plate-shaped structure and an average size in a range of 50 to 100 nm, and containing a compound represented by the following Chemical Formula 1 are stacked such that an average tilt angle formed by a surface of the matrix or a plane which is parallel with the surface of the matrix, and any axis existing on a major axis plane of a crystal is 30° or less:
M(OH)ₘ [Chemical Formula 1]
where M includes one or more selected from the group consisting of Na, K, Mg, Ca and Ba, and m is 1 or 2.

8. The method according to claim 7, wherein the step of forming the film is performed by immersing the matrix containing magnesium in a hydroxide solution.

9. The method according to claim 8, wherein the hydroxide solution includes one or more selected from the group consisting of NaOH, KOH, Mg(OH)₂, Ca(OH)₂ and Ba(OH)₂.

10. The method according to claim 8, wherein a concentration of the hydroxide solution is in a range of 1 to 20 wt %.

11. The method according to claim 8, wherein a temperature of the hydroxide solution is in a range of 90 to 200° C., and an immersion time is in a range of 1 to 180 minutes.

12. The method according to claim 8, wherein
the step of forming the film includes:
a first immersion step of immersing a matrix containing magnesium in a hydroxide solution with a concentration of N₁; and
an n^{th} immersion step of immersing the matrix in a hydroxide solution with a concentration of Nₙ,
the concentration of the hydroxide solution in the first immersion step and the n^{th} step satisfies the following Expressions 4 and 5 independently of each other, and n is an integer of 2 or more and 6 or less:
8≦N₁≦25 [Expression 4]

|Nₙ₋₁−Nₙ|<3 [Expression 5]
where N₁ and Nₙ represent a concentration of a hydroxide solution in each step, and have units of wt %.

13. The method according to claim 7, further comprising one or more steps of:
pretreating a surface before the step of forming the film; and
rinsing after the step of forming the film.
